(19) United States
(12) Patent Application Publication
(10) Pub. No.: US 2003/0031138 A1
(43) Pub. Date: Feb. 13, 2003

(54) Wireless transceivers using a simplified prism II system

(76) Inventor: Robert W. Beckwith, Clearwater, FL (US)

Correspondence Address: Robert W. Beckwith, 2794 Camden Road, Clearwater, FL, 33759, US

(21) Appl. No.: 10/246,941

(22) Filed: Sep. 19, 2002

Related U.S. Application Data
(63) Continuation-in-part of application No. 09/997,102, filed on Nov. 28, 2001, now abandoned.
(60) Provisional application No. 60/255,046, filed on Dec. 12, 2000.

(51) Int. Cl. H04B 7/005

(52) U.S. Cl. 370/278

(57) ABSTRACT

Wireless transceivers initiate Direct Sequence Spread Spectrum communications without listening for other signals. Encrypted television signals are sent and received by the wireless transceivers and the received signals are decrypted to their original form.

This application is a continuation in part of application Ser. No. 09/997,102 which in turn claimed the priority date of provisional patent application Serial No. 60/255,046 filed by Robert W. Beckwith on Dec. 12, 2000.

### SUMMARY OF THE INVENTION

A combination of Base Band Processor (BBP) and a BBP control is used which provides two way serial digital wireless communications utilizing Direct Sequence Spread Spectrum (DSSS) technology. The combination has the inherent capability to eliminate errors in communications due to data crashes. The combination communicates directly with other combinations making no further attempt to avoid data crashes. Peer to peer communications between stations in an Ad Hoc network is provided as well as between said stations and an Access Port (AP) to a distribution system. Devices based on the present invention are capable of establishing wireless connections which are transparent to the structure of Intelligent Electronic Devices (IEDs) communications protocols thereby truly replacing wires for digital communications. Selected Intersil Prism II chips together with an Atmel AT9058515 microcontroller with inventive program to control the selected Intersil HFA 3861B Base Band Processor are used in a preferred form of the present invention. Two way digital data can be exchanged with other similar devices at a selected rate of one megabit per second rate with a typical overhead of 40% yielding a payload rate of 600 kilobits per second. Encrypted suppressed NTSC video signals may be sent by equipment following the present invention.

### BRIEF DESCRIPTION OF THE DRAWINGS

FIG. 1 “FIG. 1: PEER TO PEER COMMUNICATIONS IN AD HOC NETWORK” from Intersil Note AN9829 defining peer to peer wireless communications within an Ad Hoc network.

FIG. 2 FIG. 2: from Intersil Note AN9829 defines an access port, AP, which provides wireless communications between the AP and stations within an Ad Hoc network.

FIG. 3 shows a diagram of a non-inventive Intersil Prism II wireless transceiver circuit compliant with IEEE 802.11 for comparison with the inventive wireless transceiver of FIG. 4.

FIG. 4 shows a diagram of a wireless transceiver circuit with an inventive microcontroller with program controlling the base band processor so as to provide direct peer to peer digital communications between pairs of wireless transceivers without regard to data crashes.

FIG. 5 shows an isometric view of an inventive wireless transceiver for mounting to the panel of related equipment having a USB port.

FIG. 6 shows an isometric drawing of an inventive wireless transceiver for inserting in a PCMCIA port of a computer.

FIG. 7 shows one of a pair of inventive RS232 to wireless converters for replacing wires.

FIG. 8 shows an inventive USB to wireless converter for use with computers, having a USB port, that can serve as APs. Also used at media transfer locations.

### DESCRIPTION OF THE PREFERRED EMBODIMENTS

The present inventer chooses not to follow IEEE Standard for Wireless Networks 802.11. Inventions contained herein flow from that choice.

Std. 802.11 calls for listening for wireless traffic before initiating a data transmission thus avoiding data crashes. It also provides for a network of wireless devices that pass messages from one to another around the network until delivered to a receiving station. The network expands and contracts as participating devices enter or leave an area covered by the network. For example students' laptop computers communicate forming wireless Local Area Networks (LANs) as students send messages to each other and to such APs such as school electronic libraries. Other users of wireless LANs may consist of delivery cars and trucks. Generally LANs are interconnected by the Internet. Each users' computer holds an 802.11 compliant program that runs in the background passing data packets (messages) throughout the network until the messages are delivered.

Inventive wireless devices described hereinunder do not listen for wireless traffic before initiating message packets.

A combination of Base Band Processor (BBP) and a BBP control is used which provides two way serial digital wireless communications utilizing DSSS technology. Selected Intersil Prism II chips together with an Atmel AT9058515 microcontroller with inventive program to control the selected Intersil HFA 3861B Base Band Processor are used in a preferred form of the present invention. Two way digital data can be exchanged with other similar devices at a selected rate of one megabit per second rate with a typical overhead for routing the data of 40% yielding a payload rate of 600 kilobits per second. The combination has the inherent capability to eliminate errors in communications due to data crashes and does not listen for interfering signals before initiating data transmissions. The combination communicates directly with other combinations making no further attempt to avoid data crashes.

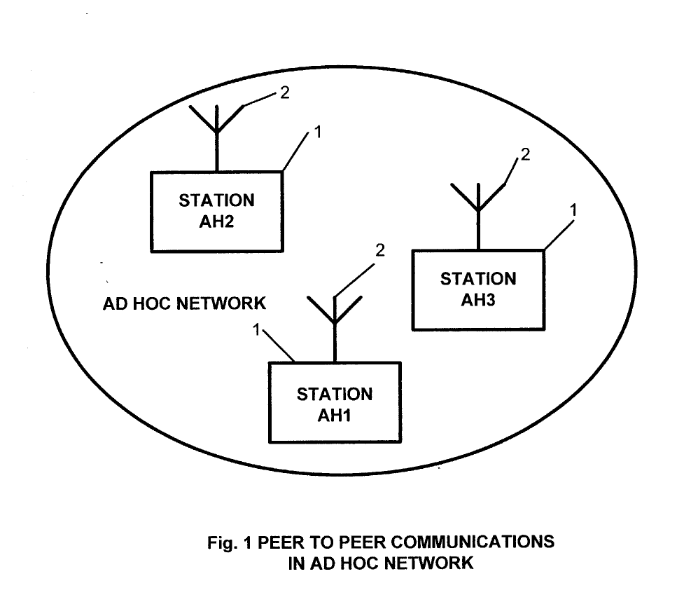

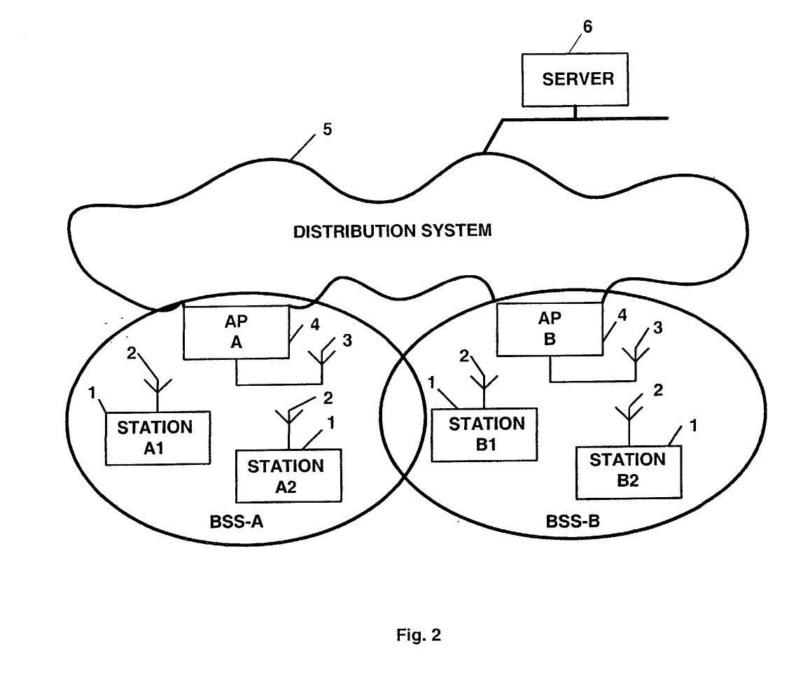

FIGS. 1 and 2 repeat figures from Intersil Application Note AN9829. These figures are useful in defining terms for discussion herein.

FIG. 1 defines an Ad Hoc network of stations 1 using peer to peer wireless communications channels between stations 1 using antennae 2.

FIG. 2 defines access ports of Basic Service Sets (BSS-A and BSS-B) to a Distribution System 5. Note that Distribution System 5 is a LAN using Ethernet for preventing data crashes on physical communications paths as required for non-wireless networks. Note that wireless technology can make no provision for an isolated communications path through the air between two stations that is equivalent to a physical LAN communications path.

Note that BSS-B is identical to BSS-A. BSSs are generally far enough apart that wireless stations in one BSS are unable to interfere with wireless stations in any other BSS in the use of coding described hereinbelow for selection of paths between stations. Note that the two BSSs do not have overlapping antennae coverage and therefore do not interfere with each other. Examples of BSSs include electric utility substations, office buildings and shopping malls. Should two BSS locations overlap, the two are treated as a single BSS.

A server 6 initiates and receives messages which must be sent through a land based distribution system 5 of physical communication paths. Typical paths include copper wire, coaxial cable and fiber optic cable.

The term IED, standing for Intelligent Electronic Devices, is used herein in referring to any devices used for said stations 1 of FIG. 1.

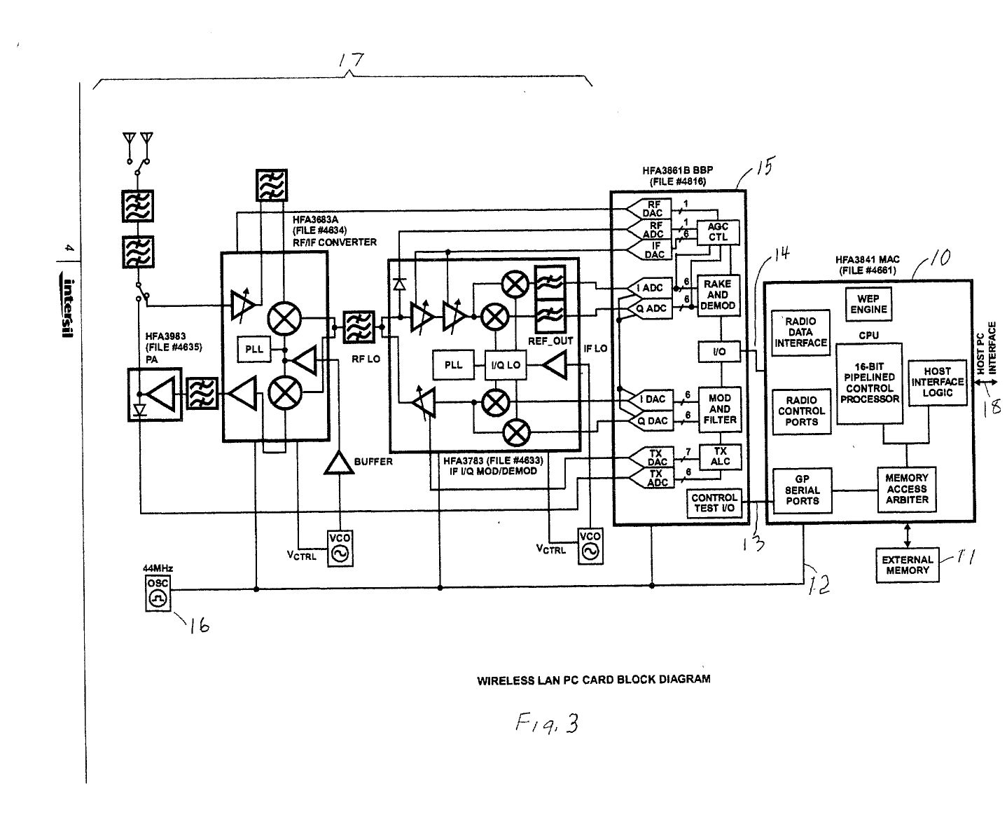

Non inventive FIG. 3 repeats “FIG. 1. WIRELESS LAN PC CARD BLOCK DIAGRAM” from Intersil Application Note 9864. This illustrates the Intersil HFA38412 Media Access Controller (MAC) 10 which supports IEEE Std 802.11 in its control of the Intersil HFA3861B Base Band Processor (BBP) 15. This effectively eliminates wireless data crashes by listening and not transmitting if an ongoing transmission is detected. The 802.11 technology also establishes a wireless network between unlimited numbers of wireless stations. Furthermore any mobile station is automatically included in the network once its presence is detected by a message it has initiated. Messages are passed around the network until received by the station to which it is directed. This networking may not be desired in some applications such as electric utility substations, for example, where it is advantageous to use the technology of the present invention to communicate between IEDs and from IEDs to a hub as an AP to a wide area network. The technology of the present invention is useful in providing communications that is restricted to stations within a wireless LAN such as a network of IEDs in a substation.

The Media Access Controller (MAC) 10 is a 16 bit processor with 256 kilobytes of external flash memory 11 and 1128 kilobytes of external RAM 11. This is ample memory and computing power to operate the inventive process of sending data without attempting to avoid data crashes. A license from Intersil could make it possible to enter our inventive programs in place of 802.11 programs using commercially available devices that support 802.11. MAC 10 communicates with BBP 15 over paths 13 and 14. The 2.4 gHz signals are formed and modulated by circuitry under bracket 17. All circuitry runs from 44 mHz oscillator 16. Communications with land based devices is via path 18.

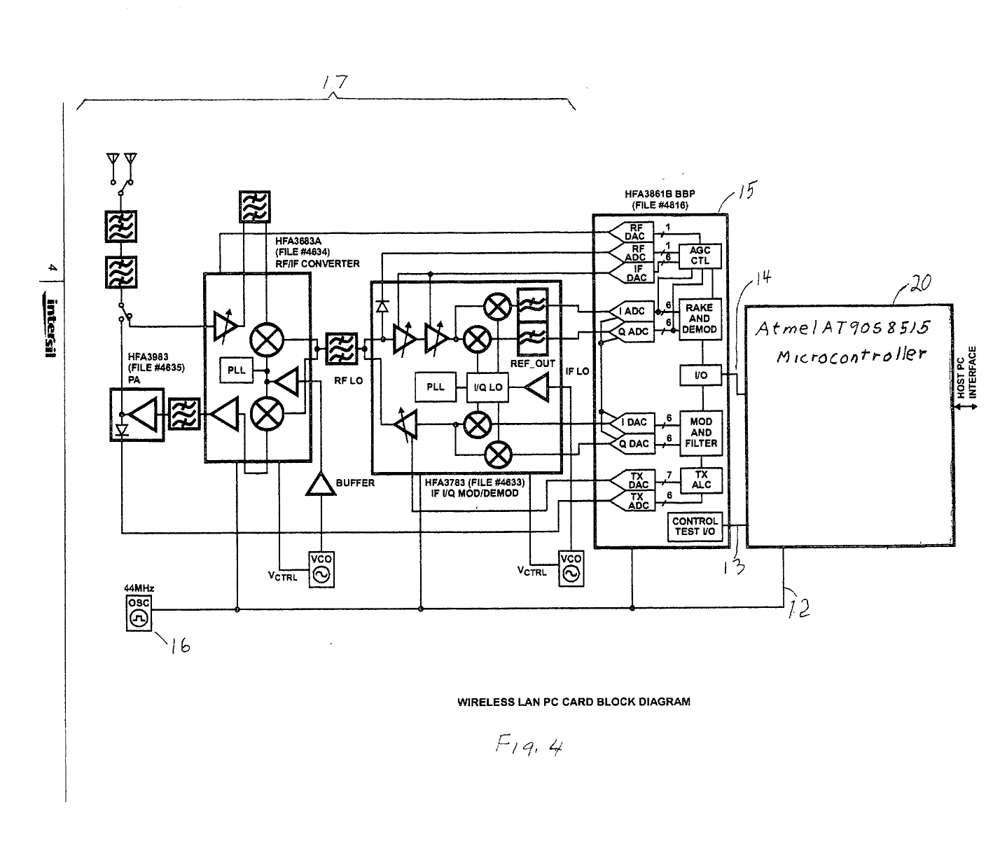

In comparison FIG. 4 shows the inventive MAC combination of the Intersil BBP 15 and an Atmel AT90S851 5 microprocessor 20 to control BBP 15. Atmel AT90S8515 microprocessor 20 has 8 kilobytes flash and 512 bytes of RAM of on board memory. The flash memory holds programs required for the inventive process.

Selectively the inventive MAC uses a one megabit per second wireless communications rate. This allows the inventive combination time to maximize the probability of sending packets without error. Other rates are possible with higher rates resulting in a higher error rate and lower rates providing even greater security. The one megabit per second rate permits an overhead of steering bits to payload bits of two to one or less. This is highly superior to compliant IEEE 802.11 technology using overhead ratios of as much as 1000 to 10,000 to eliminate data crashes and to handle message delivery.

As is well known, all digital data is sent in the form of one or more packets. This choice of a microprocessor with 512 bytes of RAM therefore permits the handling of packets of no more than 512 bytes. This adequately handles data and command packets obtainable from Beckwith Electric Co. products.

Devices utilizing the inventive combination do not listen for wireless traffic as they communicate with other inventive devices in a LAN.

Wireless peer to peer messages that are sent between stations 1 and from stations 1 to wireless hub access ports 4 create the opportunity for data crashes. Selectively, to further mitigate data crashes, message traffic management is used with the inventive system to avoid unnecessary wireless transmissions. IED events that are known to operate infrequently are only reported when they change state. An example is the change of a voltage regulating tap switch.

Simple coding systems are used in inventive wireless transceivers to select communications paths. A digital packet header has a binary code, typically of 8 bits, providing communications between 255 stations and to an AP within BSSs. Each wireless transceiver uses one of the 8 bit codes as an identity. A calling station can then use any of up to 255 other codes to select a station to receive the call. A second 8 bits is included in the message to identify the calling station. Selectively codes of other lengths than eight are used for groups of more and less than 256 total devices. Codes for each station are conveniently contained in microcontroller 20 of FIG. 4.

To accomplish this method of calling microprocessor 20 program typically includes the following steps:

1. send the 8 bit code of a station to be called,

2. include the 8 bit code identifying the calling station,

3. wait for the station called to acknowledge by sending its 8 bit identity code confirming receipt of the messages of steps 1 and 2,

4. the calling station then sends one or more message packets.

Note that processes are identical when between a station and a hub and when between two stations in direct peer to peer communications. This establishes a direct “pipeline” path from the hub to a station in which the hub can address the station directly in the protocol in which it operates as if the hub were temporarily connected to the station by wire. (Pipeline is defined as a communications channel whose protocol is invisible to those using the channel.) Similarly any two stations can communicate directly with each other as peers regardless of their protocol.

Microcontroller 20 communicates with BBP 15 via paths 13 and 14. The 2.4 gHz signals are formed and modulated by circuitry under bracket 17. All circuitry runs from 44 mHz oscillator 16.

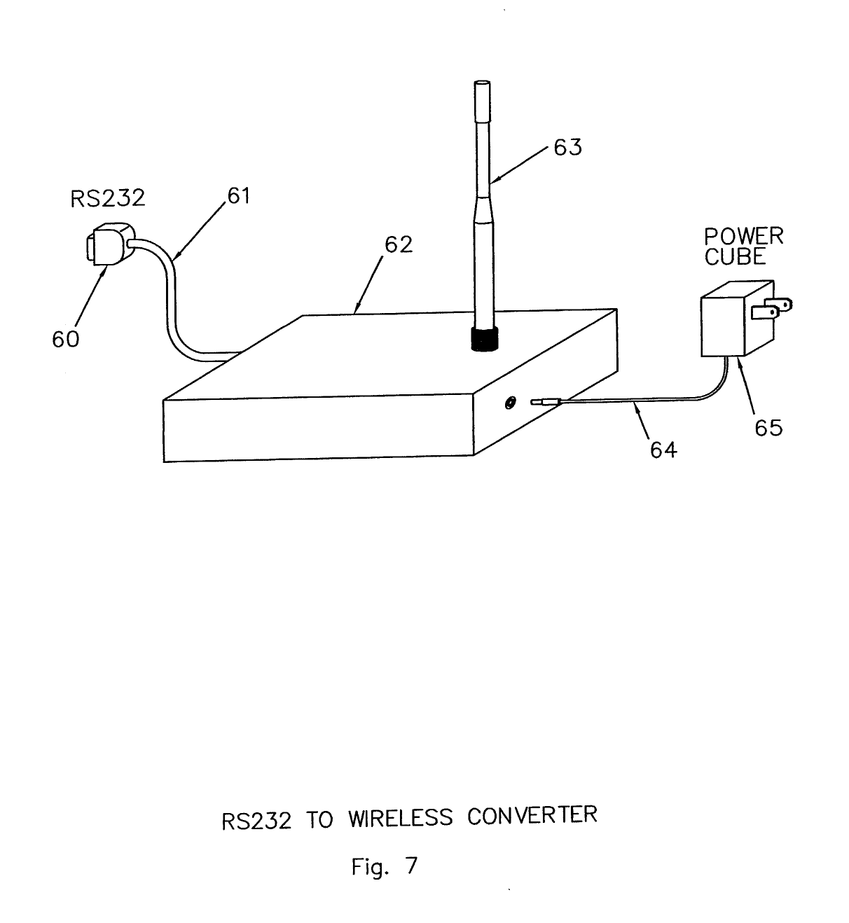

Intersil Application Note AN9829, “Brief Tutorial on IEEE 802.11 Wireless LANs”, describes operation of the Intersil Prism II system at 2.4 gHz in the ISM band. This is a band within which operation is permitted without individual station FCC licensing. The Beckwith Electric Company has developed devices using selected Intersil Prism II chips. As described below, the device shown in FIG. 7 is the preferred device in support of the present invention.

Advantages of the present invention are expected to extend to similar DSSS chip sets operating at higher frequencies.

The Prism II system utilizes DSSS technology as described in more detail in Intersil Application Note AN9829. The system provides point to point communications of binary data streams with a series of communication attempts in anticipation of a number of reasons for failure of a particular try. This includes the occasion of a data crash and retries at randomly assigned time delays, thus avoiding data crashes.

Since the inventive combination of BBP 15 and microprocessor 20 has the ability to avoid data crashes its use eliminates the need for Ethernet at levels below the wireless hubs.

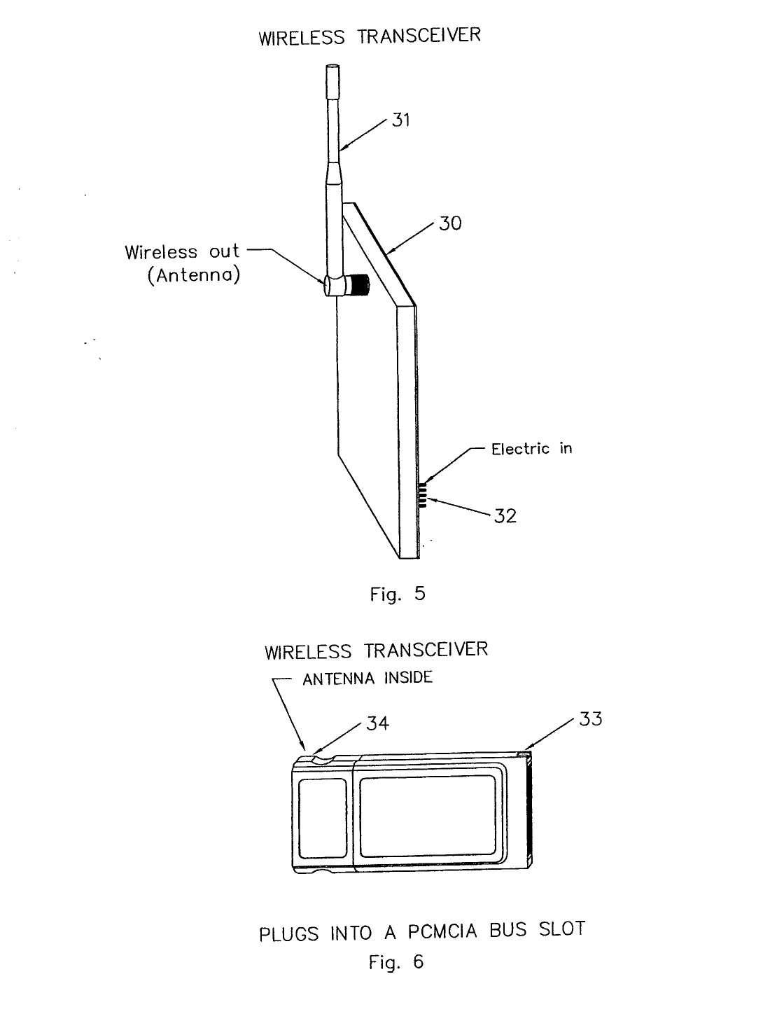

FIG. 5 is an isometric view of a Beckwith Electric Model M-2910 wireless transceiver in a container 30 using the principles of the present invention. The M-2910 devices communicate two way electric digital information signals using “electric in” ports 32 and provide signals to and from “wireless out” antennae 31. Typically the M-2901 device mounts on the front panel of any equipment requiring wireless communication capability. The electric in (and out) connection 32 is typically by an USB connector capable of bit speeds up to one megabit per second. M-2910 device speeds are sometimes limited by the capability of the equipment to which it is connected.

FIG. 6 is an isometric view of a Beckwith Electric M-2912 device 33 using the principles of the invention. The M-2912s, when inserted in PCMCIA slots of laptop or other computers, permits communications between the computers and to other devices using the inventive technology described herein. An antenna 34 is located inside of a portion of the end of device container 33 which protrudes approximately ½″ outside of the PCMCIA slot into which the device 33 is inserted. Device 33 makes a parallel bus connection with the computer into which it is inserted typically supporting one half a megabit per second communications between computers.

The M-2912 device 33 is useful in a battery operated laptop computer as a user interface to stations within an Ad Hoc network. One example is within an electric utility substation in interfacing with IEDs such as transformer tapchanger controls and transformer protection relays.

The M-2912 device is useful within offices to establish simple yet powerful local area networks between computers, each having an M-2912 device.

FIG. 7 illustrates a Beckwith Electric M-2911 RS232 to wireless digital signal converter device container 62. FIG. 7 shows RS232 connector 60 connected by cable 61 into wireless converter device 62 with wireless output from antenna 63. Converter device 62 is typically powered through connector 64 by power cube 65 to be used with a standard electrical socket, not shown. Pairs of M-2911 units are used to replace non-wireless communications paths, limited only by the speeds of the RS232 ports to which they are connected.

The device of FIG. 7 illustrates the best mode of carrying out the invention since this device has a self contained power source as compared to the devices of FIGS. 5, 6 and 8. The device of FIG. 7 also has the advantage over devices of FIGS. 5 and 6 in that cable 61 permits mounting the antenna in locations more advantageous in communications to IEDs. For example, it may be advantageous to mount the antenna on the roof of a building housing the device to which the RS232 cable is connected.

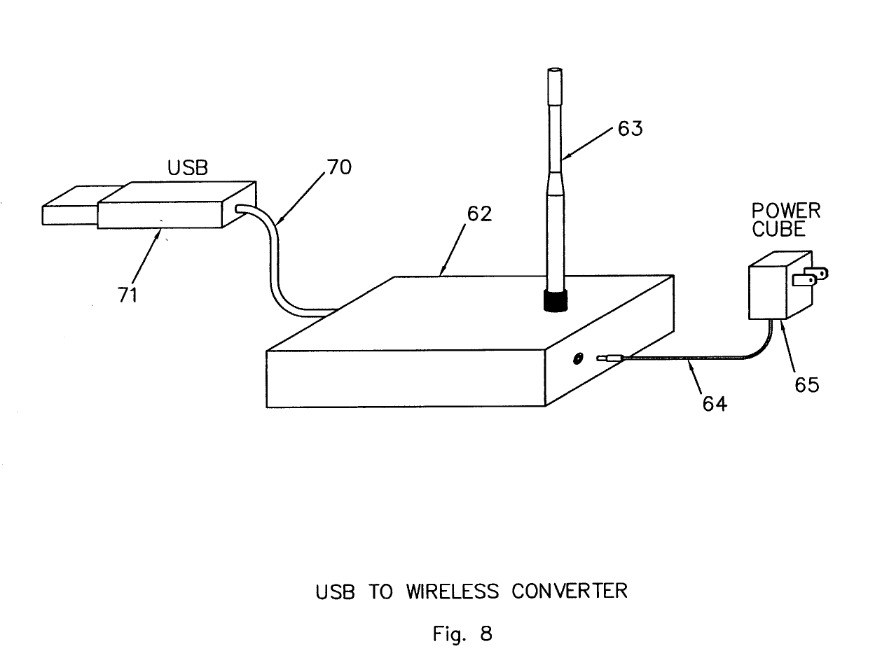

The device of FIG. 8 illustrates a converter from a USB port to wireless digital communications signals. USB connector 71 is connectable to a USB port of any computer so equipped. Connector 71 has USB cable 70 which is connected to two way signal leads in converter device 62. In general computers with USB ports are capable of communicating via the USB ports at the one megabit per second digital signal rate of the inventive devices thus typically providing one half a megabit per second exchange of payload digital data of any length.

The wireless to USB devices of FIG. 8 are used at repeating stations connecting two or more wireless transmission media. Typically two of the USB devices are combined using a coupling device which provides the following functions:

1. Power is supplied to the coupling circuitry as well as two USB wires that power wireless to USB devices that are being coupled.

2. Before a single packet or a stream of packets is sent, necessary initializing messages are sent to wireless transceivers about to exchange data.

Any two of the Beckwith Electric devices can communicate digital information between each other. Regardless of speeds of the sources of digital data, the data is divided into packets that travel at one megabit per second between wireless devices. The probability of a data crash is statistically very low thereby not interfering with packets traveling at one megabit per second.

Inventive IED devices use a microprocessor generally dedicated to the task for which it is intended, such as controlling a tapchanging mechanism in a transformer or regulator. Preferably programmed in assembly language a small overhead of communications programming is required to support the inventive wireless communications. A much more powerful processor and program technology is required for IEDs to handle Ethernet programs called for by Std. 802.11.

The 512 bytes of the Atmel AT90S851 5 microprocessor 20 (Shown in FIG. 4) is also capable of handling the standard packets used for transmission of television signals that comply with National Television Standard Committee (NTSC) standards. Wireless devices built in accordance with the present invention can therefore carry full color TV with audio.

Standard NTSC digital data packets may be passed by repeaters interconnecting a series of compatible data handling media and to a destination without change of form. Selectively streams of television (TV) packets are encrypted for security at the sending location and not de-encrypted until received at the final location.

Prior art equipment that requires de-encrypting and re-encrypting the packetized TV data at intermediate locations introduces the need for more security at the intermediate stations.

### ADVANTAGES OF THE INVENTION

1. High speed error free peer to peer communications between stations within an Ad Hoc network.

2. Powerful low cost wireless connections between computers in an office provide powerful local area networks.

3. Isolation of local area networks from other networks.

4. Ethernet programs not required in local area network computers.

5. File transfers at two seconds per megabit or faster.

6. Each computer in an local area network can serve as a hub.

7. Pairs of wireless devices that are invisible to protocols replace wires.

8. IEDs are simple and low cost as compared to those supporting IEEE 802.11.

9. Equipment for sending encrypted compressed NTSC television signals that pass unchanged through devices coupling signal transmission media.

1. A method of utilizing combinations of Direct Sequence Spread Spectrum (DSSS) Base Band Processors (BBPs) and their controllers which combinations have the inherent capability of eliminating errors due to data crashes and making no further attempt to avoid data crashes.

2. A method as in claim 1 comprising the steps of:
a) sending continuous packets of television signals,
b) encrypting said continuous packets of television signals,
c) receiving said continuous packets of encrypted television signals, and
d) decrypting said continuous packets of encrypted television signals.

3. Utilizing the method of claim 1 by adding the further steps of:
a) providing wireless transceivers for Intelligent Electronic Devices (IEDs), and
b) communicating directly from IEDs to IEDs.

4. Utilizing the method of claim 1 further comprising the steps of:
a) providing wireless transceivers at hubs,
b) providing wireless transceivers for IEDs, and
c) communicating between said hub and said IEDs.

5. A method as in claim 4 comprising the further steps of:
a) using binary codes to identify said wireless transceivers, and
b) communicating between first wireless transceivers identified by one of said binary codes and second wireless transceivers identified by other of said binary codes.

6. A method as in claims 5 further comprising the step of communicating from said hub to said IEDs using the protocol of each said IED whereby the use of Ethernet at the IED level is unnecessary.

7. Utilizing the method of claim 1 by adding the further steps of:
a) providing wireless transceivers for operation in PCMCIA recepticals,
b) placing said transceivers in PCMCIA recepticals of computers, and
c) communicating by wireless between said computers.

8. Utilizing the method of claim 1 by adding the further steps of:
a) adding wireless transceivers to Intelligent Electronic Devices (IEDs),
b) providing wireless transceivers for operation in PCMCIA recepticals,
c) placing wireless transceivers in PCMCIA recepticals of hand held computers, and
d) exchanging digital data between said hand held computers and said IEDs
wherein the hand held computers function as user interfaces with the IEDs.

9. A method as in claim 4 where said IEDs form local area networks having no connections to other networks other than through said hubs.

10. Wireless digital transceiver devices consisting of:
a) an Intersil Prism II base band processor (BBP),
b) a microprocessor controlling means for said BBP,
c) microprocessor program means for implementing ad hoc peer to peer communications between said wireless digital transceiver devices making no attempt to avoid data crashes,
c) electrical connector means for sending and receiving digital data,
d) antenna means for sending and receiving wireless signals, and
e) circuit board and container means for holding said BBP, microprocessor, supporting circuits and components, and said antenna.

11. Devices as in claim 10 further consisting of:
a) microprocessor program means for storing an 8 bit identity code for directing a wireless message to a first said wireless digital transceiver device,
b) microprocessor program means for storing an 8 bit code for receiving a wireless message from a second said wireless digital transceiver device,
c) microprocessor program means including two 8 bit binary identity codes in said wireless digital transmissions to establish two way digital communications between any two of said wireless digital transceiver devices
whereby communications can be established between as many as 256 wireless devices.

12. Wireless digital transceiver devices, said devices comprising in combination:
a) a base band processor (BBP) chip means for sending and receiving Direct Sequence Spread Spectrum (DSSS) digital signals,
b) a microprocessor means for controlling said BBP chip, and
c) program means for implementing ad hoc peer to peer communications between said wireless transceiver devices making no attempt to avoid data crashes.

13. Wireless digital transceiver devices as in claim 12 further comprising in combination:
a) microprocessor program means for storing 8 bit identity codes for directing wireless messages to first said wireless devices,
b) microprocessor program means for storing 8 bit codes to identify second devices originating wireless messages received by said first devices,
c) microprocessor program means for including two 8 bit binary identity codes in said wireless transmissions to establish two way digital communications between any two of said wireless devices
whereby communications can be established between as many as 256 wireless devices.

14. Wireless digital transceiver devices as in claim 13 further comprising microprocessor program means for a first device answering a wireless transmission intended for said first device by recognizing said first devices' 8 bit identity code included in the message received at the start of a message from a second device.

15. Wireless digital transceiver devices as in claim 14 further comprising in combination:
a) wireless devices for operation in PCMCIA recepticals of computers,
b) power obtaining means for operation of said wireless devices from said computers via said PCMCIA ports,
c) means for including antennae in said wireless digital transceiver devices for sending and receiving wireless signals, and
d) microprocessor program means for two way conversion of messages between serial form as required by wireless transmissions and parallel form as required by PCMCIA bus ports.

16. Wireless digital transceiver devices as in claim 14 further comprising in combination:
a) USB connection means for connecting said wireless digital transceiver devices to computers via USB ports, and
b) microprocessor programming means for communicating digital information of any length between said computers.

17. Devices as in claim 14 further comprising in combination:
a) RS232 connector means for connecting said devices to existing Intelligent Electronic Devices (IEDs),
b) microprocessor programs for providing two way digital communications between IEDs equipped with said wireless digital transceiver devices.

18. Devices as in claims 11 further comprising in combination the use of other than 8 bit codes for identifying more and less than a total of 256 stations.

19. Devices as in claims 13 further comprising in combination the use of other than 8 bit codes for identifying more and less than a total of 256 stations.

20. Devices as in claims 11 further comprising in combination the use of other than 8 bit codes for identifying more and less than a total of 256 stations.

21. A device for sending encrypted television signals said device comprising in combination:
a) a source of television signals,
b) encrypting means for encrypting said television signals,
c) wireless digital sending means for sending said encrypted television signals,
d) wireless digital receiving means for receiving said encrypted television signals, and
e) decrypting means for decrypting said encrypted television signals
whereby the original television signals are reproduced.
